(19) United States
(12) Patent Application Publication
(10) Pub. No.: US 2014/0236602 A1
(43) Pub. Date: Aug. 21, 2014

(54) Synthesizing Vowels and Consonants of Speech

(71) Applicants: Brandon R. Graham, Cottonwood Heights, UT (US); Jacob G. Nieveen, Orem, UT (US)

(72) Inventors: Brandon R. Graham, Cottonwood Heights, UT (US); Jacob G. Nieveen, Orem, UT (US)

(73) Assignee: Utah State University, North Logan, UT (US)

(21) Appl. No.: 14/186,152

(22) Filed: Feb. 21, 2014

Related U.S. Application Data
(60) Provisional application No. 61/767,613, filed on Feb. 21, 2013.

(51) Int. Cl. G10L 13/02

(52) U.S. Cl. CPC G10L 13/02
USPC 704/258

(57) ABSTRACT

For speech synthesis, a vowel module sequentially applies a vowel filter set to form a vowel with a source signal. The vowel filter set is selected from a logical arc traversing a vowel filter array. The vowel filter array includes a plurality of vowel filters organized as a logical space. Vowel filters traversed by the logical arc are selected. A consonant module sequentially applies a consonant filter set from a consonant filter array to form a consonant with the source signal. The consonant filter set is selected in response to a discrete consonant value.

### CROSS-REFERENCE TO RELATED APPLICATIONS

This application claims priority to U.S. Provisional Patent Application No. 61/767,613 entitled “DIRECT INPUT DIGITAL SPEECH SYNTHESIS” and filed on Feb. 21, 2013 for Brandon Graham et al., which is incorporated herein by reference.

### FIELD

The subject matter disclosed herein relates to speech synthesis based on synthesizing vowels and consonants.

### BACKGROUND

Speech synthesis is employed to add synthetic speech to automated interfaces, signals, and the like. However, generating authentic vowel and consonant sounds is difficult.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of the speech synthesis system;

FIG. 2A is a schematic drawing illustrating one embodiment of a filter array;

FIG. 2B is a schematic drawing illustrating one embodiment of a vowel filter array;

FIG. 2C is a schematic block diagram illustrating one embodiment of filter data;

FIG. 2D is a schematic block diagram illustrating one embodiment of a filter set;

FIG. 2E is a schematic drawing illustrating one embodiment of a logical arc traversing a vowel filter array;

FIG. 2F is a schematic drawing illustrating one alternate embodiment of a logical arc traversing a vowel filter array;

FIG. 2G is a schematic block diagram illustrating one embodiment of an input signal translation table;

FIG. 3A is a schematic of a touchpad interface;

FIG. 3B is a schematic drawing illustrating one embodiment of a consonant touchpad;

FIG. 4 is a schematic block diagram illustrating one embodiment of the computer; and

FIG. 5 is a flow chart diagram illustrating one embodiment of a speech synthesis method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Embodiments of the present disclosure may be implemented as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object oriented programming language such as Java, Smalltalk, Python, Ruby, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

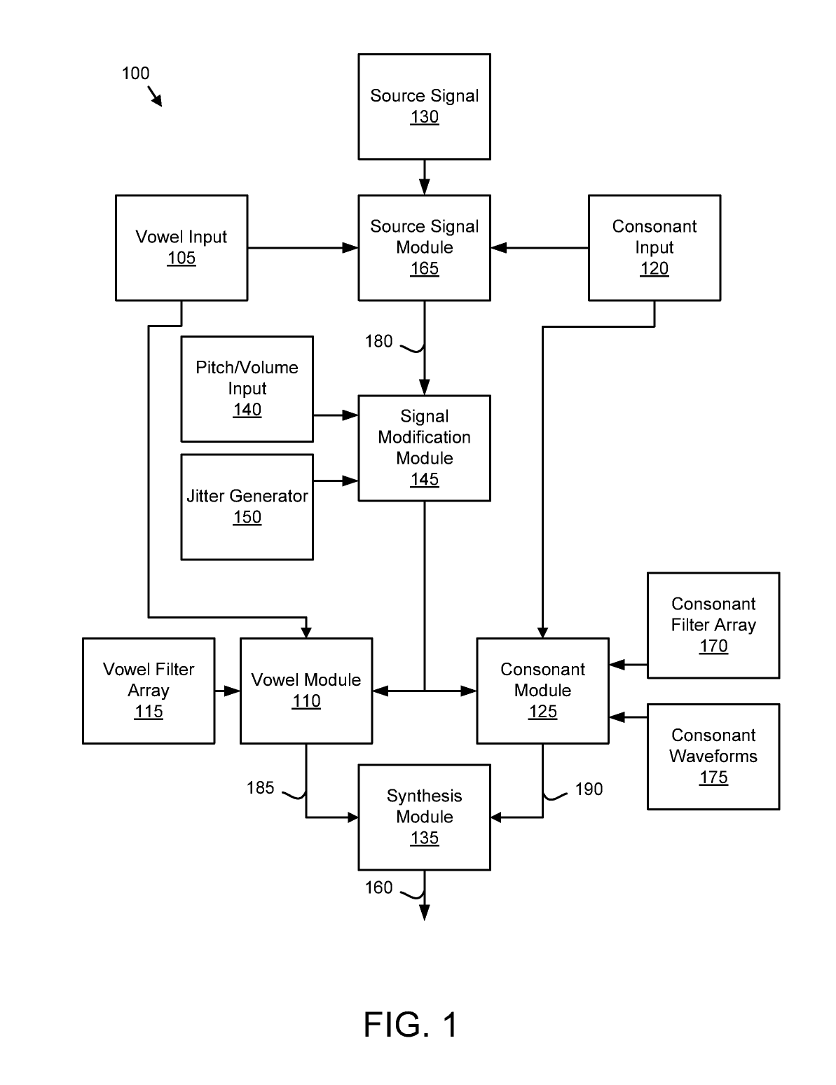

FIG. 1 is a schematic block diagram illustrating one embodiment of a speech synthesis system 100. The system 100 may synthesize speech from a vowel input 105 and a consonant input 120. In one embodiment, the system 100 synthesizes the speech for a source signal 130. The system 100 includes a source signal module 165, a pitch/volume input 140, a jitter generator 150, a signal modification module 145, a vowel filter array 115, a vowel module 110, a consonant filter array 170, consonant waveforms 175, a consonant module 125, and a synthesis module 135. In addition, the system 100 may include the vowel input 150, the consonant input 120, and the source signal 130.

In the past, speech synthesis systems and methods have generated a list of phonemes from an input such as text. The phonemes are then typically rendered using predefined waveforms. Unfortunately, the use of predefined waveforms often results in synthesized speech that sounds unnatural and inauthentic. In addition, text or phoneme input is often required.

The embodiments described herein select and sequentially apply a vowel filter set to form a vowel with a source signal and sequentially apply a consonant filter set to form a consonant with the source signal to generate synthesized speech as will be described hereafter. The use of flexible vowel filter sets and consonant filter sets support the generation of more authentic sounding speech, particularly speech generated for a source signal 130. In addition, vowels and consonants may be generated without direct text or phoneme input.

The source signal 130 may comprise one or more of silence, a periodic waveform, white noise, a stored signal, a synthesized signal, and an input signal. For example, the source signal 130 may be a zero voltage input, a sinusoidal waveform, white noise from white noise generator, pink noise from a noise generator, a stored analog signal, a stored digital signal, a stored digital signal that is converted into an analog waveform, and the like. In one embodiment, the source signal 130 may be a microphone input, a pedal input such as from an instrument pedal, an input from an instrument, and the like.

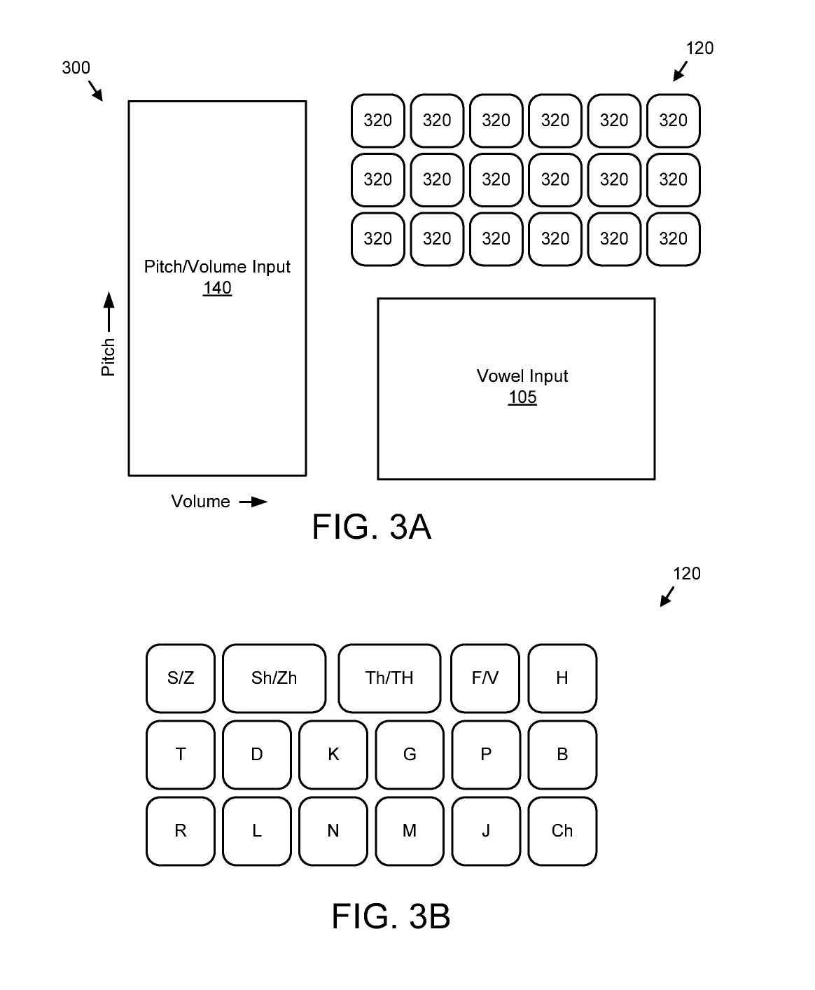

The vowel input 105 receives a logical arc that traverses the vowel filter array 115. The logical arc may be received from an input device as will be described hereafter in FIG. 3A. In addition, a joystick vowel input 105 may receive the logical arc. Alternatively, the logical arc may be generated in response to a vowel value. For example, the vowel input 105 may receive an International Phonetic Alphabet (IPA) value that specifies a vowel sound and generate the logical arc in response to the IPA value.

The consonant input 120 receives a discrete consonant value. The consonant value may be from the input device as will be described hereafter in FIGS. 3A-B. In addition, a joystick consonant input 120 may receive the discrete consonant value. Alternatively, the consonant input 120 may receive an IPA value that specifies a consonant sound and generate the discrete consonant value in response to the IPA value.

The source signal module 165 may select one source signal 180 from the one or more source signals 130. In one embodiment, the source signal module 165 selects the one source signal 130 as a function of the logical arc and the discrete consonant value.

The jitter generator 150 may generate a jitter signal. In one embodiment, the jitter generator 150 generates white noise and filters the white noise with the low pass filter to generate the jitter signal. The low pass filter may be a third order Butterworth low pass filter with a cutoff frequency in the range of 2 to 10 Hz.

The pitch/volume input 140 may receive a pitch/volume pair selection. The pitch/volume pair may be from a pitch/volume array of a plurality of pitch/volume pairs. The pitch/volume pair may be selected using the input device of FIG. 3A. Alternatively, a joystick pitch/volume input 140 may receive the pitch/volume pair selection. The pitch/volume pair may specify a pitch modification and a volume modification. In one embodiment, the pitch modification specifies a change in pitch. Alternatively, the pitch modification may specify an absolute pitch. Similarly, the volume modification may specify a change in volume. Alternatively, the volume modification may specify an absolute volume.

The signal modification module 145 may modify the selected source signal pitch and selected source signal volume of the source signal 180 with the pitch modification and/or the volume modification of the pitch/volume pair. For example, the signal modification module 145 may modify the selected source signal 180 to have the pitch and volume specified by the pitch/volume pair. Alternatively, the signal modification module 145 may modify the selected source signal 180 by changing the source signal pitch by the value of the pitch modification and by changing the source signal volume by the value of the volume modification. The signal modification module 145 may further modify the source signal 180 with the jitter signal. In one embodiment, the source signal 180 is modulated with the jitter signal.

The vowel module 110 may select a vowel filter set from the vowel filter array 115 using the logical arc from the vowel input 105. The vowel filter array 145 comprises a plurality of vowel filters organized in a logical space. The vowel filters that are traversed by the logical arc are selected for the vowel filter set as will be described hereafter.

The vowel module 110 may sequentially apply the vowel filter set to the source signal 180 to form a vowel 185 with the source signal 180. Thus the vowel 185 may be integrated into the source signal 180 to form the vowel 185.

The consonant module 125 may select a consonant filter set from the consonant filter array 170 in response to the discrete consonant value from the consonant module 120. In one embodiment, the system 100 includes one consonant filter array 170 for each consonant sound. Alternatively, the system 100 may include one consonant filter array 170 for each discrete consonant value. In one embodiment, a consonant filter set of the consonant filter array 170 is associated with each of a plurality of discrete consonant values. The consonant module 125 may further sequentially apply the consonant filter set to the source signal 180 to form a consonant 190 with the source signal 180.

The synthesis module 135 may synthesize a speech signal 160 from the vowel 185 with the source signal 180 and the consonant 190 with the source signal 180. In one embodiment, the synthesis module 135 sums the vowel 185 with the source signal 180 and the consonant 190 with the source signal 180 to generate the speech signal 160.

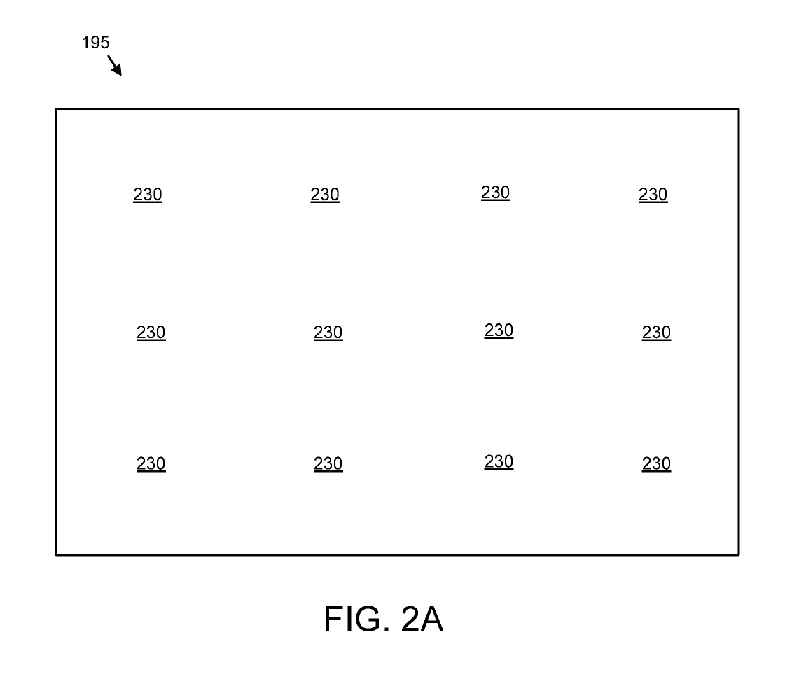

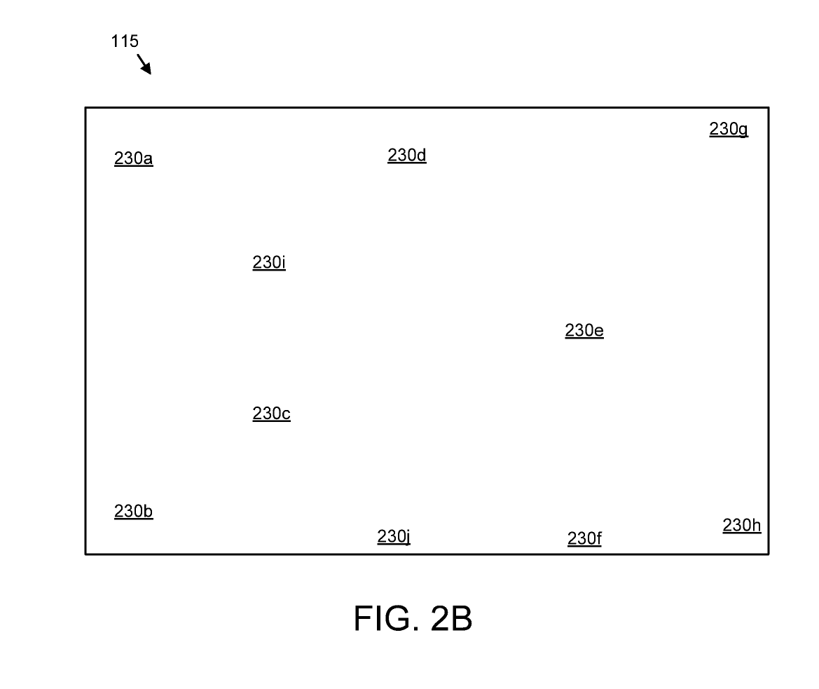

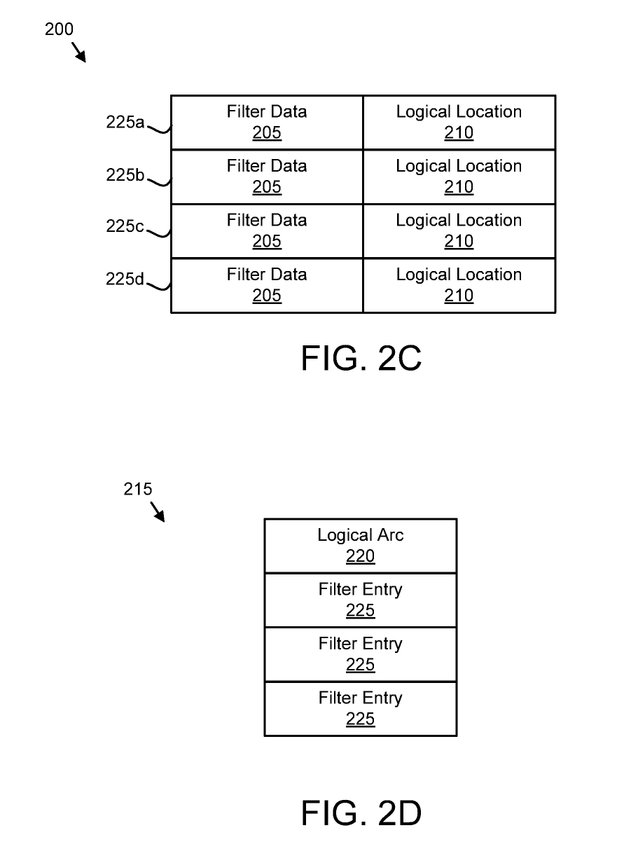

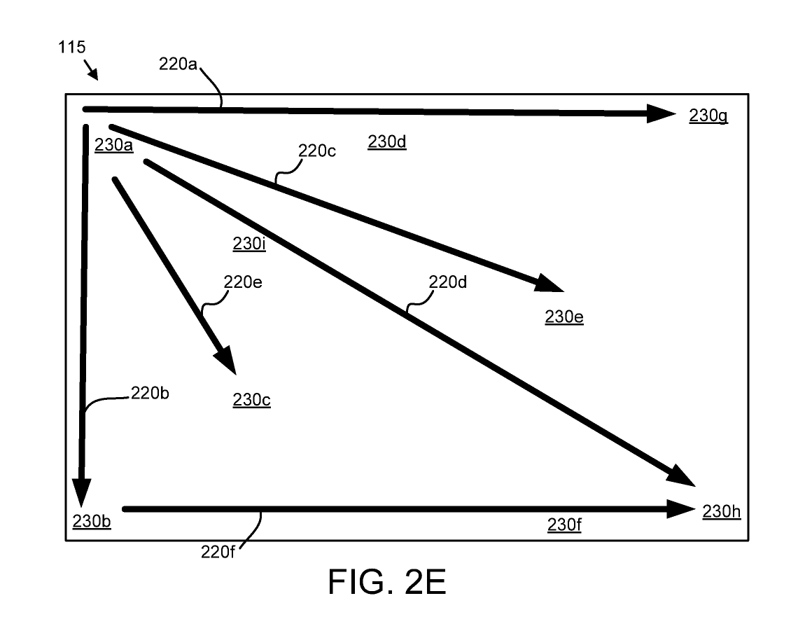

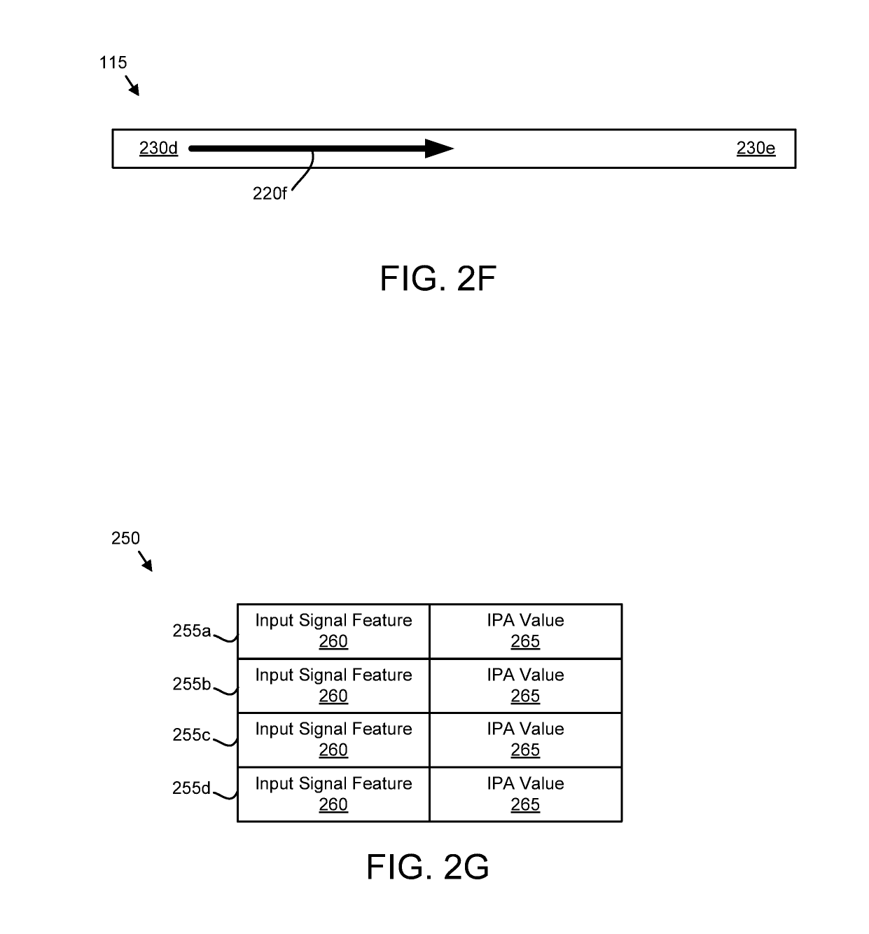

FIG. 2A is a schematic drawing illustrating one embodiment of a filter array 195. The filter array 195 may be the vowel filter array 115 or the consonant filter array 170. The vowel filter array 195 includes gradations of a plurality of filters 230 organized in a logical space. In the depicted embodiment, the filters 230 are organized in a two-dimensional array. Alternatively, the filters 230 of the filter array 195 may be organized in a one-dimensional array.

In one embodiment, each consonant sound has a consonant filter array 170. Alternatively, the consonant filter array may be organized as a three dimensional array, with the third dimension distinguishing consonant sounds.

In one embodiment, the filters 230 comprise digital filter coefficients. Alternatively, the filters 230 comprise line spectral pair representations of filter coefficients. In addition, the filters 230 comprise transfer functions and/or difference equations.

In one embodiment, the filter array 195 l is calculated as needed from one or more anchor filters 230. For example, filters 230 that are logical disposed in a logical coordinate area bordered by three anchor filters 230 may be calculated as needed as function of the three anchor filters 230. The filters 230 may be pre-calculated and/or calculated at run time.

In one embodiment, coefficients for a first filter 230 may be interpolated from the coefficients of filters 230 with logically adjacent coordinates. Alternatively, the filter responses of the filters 230 with logically adjacent coordinates may be interpolated to generate the filter response of the first filter 230. Coefficients for the first filter 230 may be calculated from the interpolated filter response and recorded for the first filter 230.

In one embodiment, a logical arc may traverse the vowel filter array 115 embodiment of the filter array 195. Vowel filters 230 that logically intersect the path of the logical arc may be included in a vowel filter set. The vowel filters 230 are arranged so that one or more logical arcs select vowel filter sets that form desired vowel sounds.

In one embodiment, one or more anchor vowel filters 230 are logically positioned within the vowel filter array 115. Additional vowel filters 230 may be synthesized in gradations from the anchor vowel filters 230 to fill additional logical positions between the anchor vowel filters 230. As a result, a vowel filter array 115 with a large number of vowel filters 230 may be generated from a smaller number of anchor vowel filters 230.

In an alternative embodiment, each vowel filter 230 is uniquely created and logically positioned within the vowel filter array 115. As a result, a vowel filter array 115 with the unique speech pattern and/or accent may be generated.

The consonant filter array 170 embodiment of the filter array 195 may have the same organization as the vowel filter array 115, with consonant filters 230 logically positioned in gradations within the consonant filter array 170 just as vowel filters 230 are logically positioned within the vowel filter array 115. In one embodiment, each of a plurality a discrete consonant values may be associated with a consonant filter set comprising consonant filters 230 in the consonant filter array 170.

FIG. 2B is a schematic drawing illustrating one embodiment of a vowel filter array 115. Specified vowel filters 230 are depicted in logical positions within the vowel filter array 115. In one embodiment, the specified vowel filters 230 have the IPA vowel values as described in Table 1.

TABLE 1

| IPA vowel | |
|---|---|
| value | Reference |
| u | 230a |
| i | 230b |
| [symbol] | 230i |
| o | 230d |
| e | 230j |
| Λ | 230e |
| ε | 230f |
| α | 230g |
| æ | 230h |

Vowel filters 230 in logical positions between the specified vowel filters 230 of Table 1 may be determined by interpolating gradations of intermediate vowel sounds. For example, the vowel filters 230 logical positions between the specified vowel filters 230 of Table 1 may be calculated as a function of the logically nearest specified vowel filters 230 and a logical distance to each of the specified vowel filters 230.

FIG. 2C is a schematic block diagram illustrating one embodiment of filter data 200. The filter data 200 may organized as data structures and be stored in a memory. In the depicted embodiment, each entry 225 of the filter data 200 includes a filter data 205 and a logical location 210 for a filter 230 in a filter array 195. The filter data 205 may specify one of a vowel filter and a consonant filter. The logical location 210 may be a logical coordinate within the vowel filter array 115 and/or the consonant filter array 170.

FIG. 2D is a schematic block diagram illustrating one embodiment of a filter set 215. The filter set 215 may be organized as data structures and stored in a memory. The filter set 215 may be one of a vowel filter set 215 and a consonant filter set 215.

The filter set 215 may include a logical arc 220. The logical arc 220 may describe a plurality of sequential logical positions across one of the vowel filter array 115 and/or the consonant filter array 120. For example, the logical positions may be logical coordinates. In addition, the logical coordinates may be sequentially organized such that a logical linear direction is maintained. Alternatively, the logical coordinates may be sequentially organized such that a logical curve is maintained. In one embodiment, the logical curve does not exceed one part change of direction for 4 parts linear progression in an original direction.

The filter set 215 also includes a one or more filter entries 225. In one embodiment, the filter entries 225 point to the filter entries 225 of FIG. 2D.

FIG. 2E is a schematic drawing illustrating one embodiment of logical arcs 220 traversing a vowel filter array 115. In the depicted embodiment, the logical arcs 220 traverse the vowel filter array 115 of FIG. 2B. However, other logical arcs 220 may traverse other filter arrays 195 including vowel filter raise 115 and consonant filter arrays 170 without limitation.

In the depicted embodiment, the logical arcs 220 linearly traverse the vowel filter array 115 with linear logical directions. The logical arcs 220 may also traverse the vowel filter array 115 as logical curves. A logical arc 220 generates a vowel filter set 215 that is a sequential list of the filter data 205 at logical locations 210 traversed by the logical arc 220. In one embodiment, the depicted logical arcs 220 generates vowel filter sets 215 for the vowel sounds listed in Table 2

TABLE 2

| Logical Arc | |
|---|---|
| Reference | Vowel Sound |
| 220a | “Wah” |
| 220b | “We” |
| 220c | “Wuh” |
| 220d | “Waa” |
| 220e | “Wi” |

FIG. 2F is a schematic block diagram illustrating one alternate embodiment of a logical arc 220 traversing a vowel filter array 115. The vowel filter array 115 may be a one dimensional array. The logical arc 220 may be generated using an instrument pedal with forward and back positions, wherein rocking the pedal generates the logical arc 220.

FIG. 2G is a schematic block diagram illustrating one embodiment of a input signal translation table 250. The input signal translation table 250 may be organized as a data structure in a memory. The input signal translation table 250 may include a plurality of entries 255. Each entry 255 may associate a input signal feature 260 with an IPA value 265. The input signal feature 260 may be a signal power, a signal root mean squared power, a signal amplitude, a chord, a frequency, and the like for a specified sampling interval. In one embodiment, the IPA value 265 includes one or more consonant values, one or more vowel values, or combinations thereof.

FIG. 3A is a schematic of a touchpad interface 300. In the depicted embodiment, the touchpad interface 300 includes the pitch/volume input 140, the consonant input 120, and the vowel input 105.

The pitch/volume input 140 is depicted as a space of pitch/volume pairs on the touchpad interface 300. The vertical axis represents pitch that increases in an up direction. The horizontal axis represents volume that increases in a right direction. Selecting a position within the space of the pitch/volume input 140 selects a pitch/volume pair. For example, a first pitch/volume pair may be selected in response to a user touching a corresponding position on the pitch/volume input 140.

The consonant input 120 is depicted as a plurality of touch keys 320. Each touch key 320 may represent a discrete consonant value. A user may touch a touch key 320 to select the corresponding discrete consonant value.

In one embodiment, the touch keys 320 are organized by consonant type. For example, touch keys 320 for consonant groups such as fricative consonants, stop consonants, liquid consonants, nasal consonants, glottal consonants, and consonant diaphones may each be grouped together. In one embodiment, a consonant group may be organized in a horizontal line of touch keys 320.

The vowel input 105 may be a touch interface corresponding to the vowel filter array 115, wherein a position on the vowel input 105 corresponds to a logical location 210 of the vowel filter array 115. The user may manually describe a logical arc 220 by touching the touch interface in an arc to generate the logical arc 220 and select the vowel filter set 215. For example, drawing a finger from the upper left-hand corner to the lower left-hand corner of the vowel input 105 may generate the logical arc 220b of FIG. 2E and the corresponding vowel sound of Table 2.

FIG. 3B is a schematic drawing illustrating one embodiment of a consonant touchpad consonant input 120. A plurality of touch keys 320 is shown. Each touch key 320 is assigned a specified discrete consonant value.

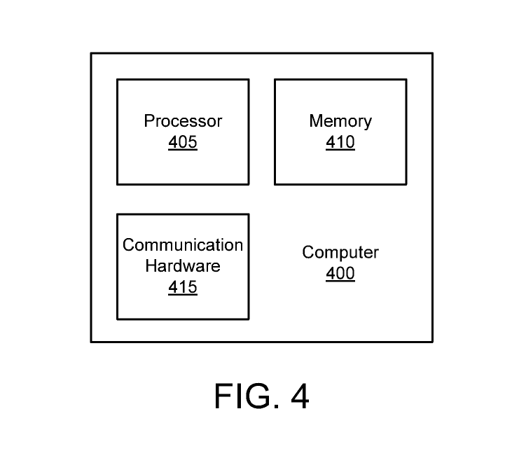

FIG. 4 is a schematic block diagram illustrating one embodiment of the computer 400. The computer 400 may perform one or more functions of the system 100. The computer 400 may include a processor 405, a memory 410, and communication hardware 415. The memory 410 may be a semiconductor storage device, a hard disk drive, an optical storage device, a micromechanical storage device, or combinations thereof. The memory 410 may store program code. The processor 405 may execute the program code.

The communication hardware 415 may communicate with other devices. The communication hardware may include one or more of analog audio inputs, digital audio inputs, analog audio outputs, and digital audio outputs.

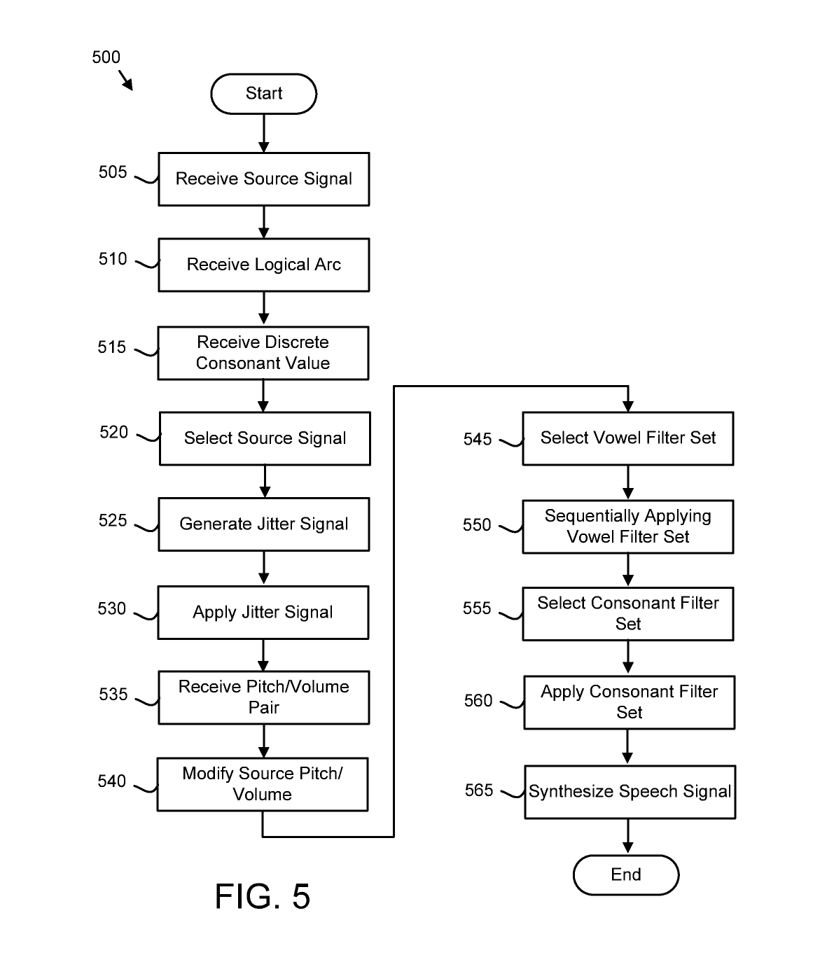

FIG. 5 is a flow chart diagram illustrating one embodiment of a speech synthesis method 500. The method 500 may synthesize speech. In one embodiment, the method 500 performs the functions of the system 100. The method 500 may be performed by the processor 405. Alternatively, the method 500 may be embodied in a memory 410 such as a computer readable storage medium storing program code. The program code may be executed by the processor 405 to perform the method 500.

The method 500 starts, and in one embodiment, the source signal module 165 receives 505 one or more source signals 130. The source signals 130 may comprise one or more of silence, a periodic waveform, white noise, pink noise, a stored signal, a synthesized signal, and an input signal.

In addition, the vowel input 105 may receive 510 the logical arc 220. The logical arc 220 may comprise filter data 205 for a single filter 230. In one embodiment, the logical arc 220 is manually input on a touchpad vowel input 105 such as the touchpad vowel input 105 of FIG. 3A. Alternatively, the logical arc 220 may be generated in response to a phonetic input such as a text input, a phoneme input, or the like. In one embodiment, the phonetic input is an IPA value.

In one embodiment, the IPA value may be the IPA value 265 from the input signal translation table 250. The vowel input 105 may receive a musical cord source signal 130. The vowel input 105 may identify the cord 260 associated with the musical cord and the IPA value 265 associated with the cord 260.

In one embodiment, the vowel input 105 may be from the instrument pedal. The instrument pedal may select a logical arc 220 from a one dimensional vowel filter array 115.

The consonant input 120 further receives 515 a discrete consonant value. In one embodiment, a touch key 320 representing the discrete consonant value may be selected from the consonant input 120 of FIGS. 3A-B. Alternatively, the discrete consonant value may be generated in response to a phonetic input such as a text input, a phoneme input, or the like. The phonetic input may be an IPA value.

In one embodiment, the discrete consonant value may be determined from a musical cord. For example, the source signal 130 may be a guitar chord. The consonant input 120 may identify an input signal feature 260 associated with the guitar chord and the IPA value 265 associated with the cord 260. The IPA value 265 may be the discrete consonant value.

In one embodiment, the consonant input 120 may be from the instrument pedal. The instrument pedal may select a logical arc 220 from a one dimensional consonant filter array 170.

The source selection module 165 may further select 520 a source signal 180 from the one or more source signals 130. The source signal 180 may be selected as a function of the logical arc 220 and the discrete consonant value.

The jitter generator 150 may generate 525 the jitter signal. In addition, the signal modification module 145 may modify the source signal 180 by applying 530 the jitter signal to the source signal 180. In one embodiment, the source signal 180 is modulated with the jitter signal.

The pitch/volume input 140 may receive 535 a pitch/volume pair. In one embodiment, the user may select the pitch/volume pair from the pitch/volume input 140 depicted in FIG. 3A by touching a portion of the pitch/volume input 140. Alternatively, the pitch/value pair may be automatically generated in response to a prosody input.

The signal modification module 145 may modify 540 the pitch and volume of the source signal 180 in response to the pitch/volume pair. In one embodiment, the pitch/volume pair specifies an absolute pitch and an absolute volume for the source signal 180 and the signal modification module 145 modifies 540 the source signal 180 to conform to the absolute pitch and the absolute volume.

Alternatively, the pitch/volume pair may specify a relative pitch and a relative volume. For example, the relative pitch may be plus one octave and the relative volume may be −1 decibel (db). As a result, the signal modification module may increase the pitch of the source signal 180 by one octave and decrease the volume of the source signal 180 by 1 db.

The vowel module 110 may select 545 of vowel filter set 215 from the logical arc 220. In one embodiment, each vowel filter 230 of the vowel filter array 115 traversed by the logical arc 220 is included in the vowel filter set 215. The vowel module 110 may further sequentially apply 550 the vowel filter set 215 to the source signal 180. In one embodiment, the vowel filter set 215 is applied 550 to the source signal 180 over a first specified time interval.

Alternatively, each vowel filter 230 of the vowel filter set 215 is applied to the source signal 180 for a second specified time interval. By applying each vowel filter 230 for the second specified time interval, the duration of a resulting vowel sound may be controlled.

The consonant module 125 may select 555 a consonant filter set 215 from the consonant filter array 170 in response to the discrete consonant value. The consonant module 125 may further sequentially apply 560 the consonant filter set 215 to the source signal 180 to form a consonant 190 with the source signal 180. The consonant filter set 215 may be applied 560 to the source signal 180 over the first specified time interval.

Alternatively, each consonant filter 230 of the consonant filter set 215 may be applied to the source signal 180 for the second specified time interval. By applying each consonant filter 230 for the second specified time interval, the duration of a resulting consonant sound may be controlled.

The synthesis module 135 may synthesize 565 the speech signal 160 from the vowel 185 with the source signal 180 and the consonant 190 with the source signal 180 and the method 500 ends. In one embodiment, the synthesis module 135 calculates an intermediate filter set that combines one or more vowel filter sets 215 with more or more consonant filter sets 215. The filter sets 215 may be combined by sequentially appending filter sets 215, interpolating values for concurrent filter sets 215, or combinations thereof. The source signal 180 and the consonant 190 with the source signal 180 may be summed to generate the speech signal 160. The method 500 supports low-level control of the pitch and duration of the vowel and consonant speech sounds, allowing the user to express emotion and add personality to the synthesized voice

The embodiments select the vowel filter set 215 from the logical arc 220 traversed in the vowel filter array 115. The vowel filter set 215 produces an authentic vowel sound when applied to the source signal 180. In addition, the embodiments select the consonant filter set 215 in response to the discrete consonant value. The consonant filter set 215 produces an authentic consonant sound when applied to the source signal 180. By sequentially applying the vowel filter set 215 and/or the consonant filter set 215 to the source signal 180 the embodiments form vowel and consonant sounds with the source signal 180, generating authentic synthesize speech.

1. A method for speech synthesis comprising:
sequentially applying, by use of a processor, a vowel filter set to form a vowel with a source signal, the vowel filter set selected from a logical arc traversing a vowel filter array, the vowel filter array comprising a plurality of vowel filters organized as a logical space, wherein vowel filters traversed by the logical arc are selected; and
sequentially applying a consonant filter set from a consonant filter array to form a consonant with the source signal, the consonant filter set selected in response to a discrete consonant value.

2. The method of claim 1, the method further comprising modifying the source signal with a jitter signal.

3. The method of claim 2, the method further comprising:
generating white noise; and
filtering the white noise with a third order Butterworth low pass filter with a cutoff frequency in the range of 2 to 10 Hz to generate the jitter signal.

4. The method of claim 1, wherein the vowel filter array is a one dimensional array.

5. The method of claim 1, wherein the vowel filter array is a two dimensional array.

6. The method of claim 1, wherein the vowel filter array comprises filter gradations between “u,” “i,” “U,” “I,” “o,” “e” “Λ,” “ε,” “α,” and “æ” vowels.

7. The method of claim 1, the method further comprising:
selecting a pitch/volume pair from a pitch/volume input; and
modifying the source signal pitch and source signal volume with the pitch/volume pair.

8. The method of claim 1, the method further comprising selecting the source signal based on the discrete consonant input and the logical arc.

9. The method of claim 8, wherein the source signal is selected from the group consisting of silence, white noise, a stored signal, a synthesized signal, and an input signal.

10. An apparatus comprising:
a vowel module that sequentially applies a vowel filter set to form a vowel with a source signal, the vowel filter set selected from a logical arc traversing a vowel filter array, the vowel filter array comprising a plurality of vowel filters organized as a logical space, wherein vowel filters traversed by the logical arc are selected; and
a consonant module that sequentially applies a consonant filter set from a consonant filter array to form a consonant with the source signal, the consonant filter set selected in response to a discrete consonant value.

11. The apparatus of claim 10, the apparatus further comprising a signal modification module that modifies the source signal with a jitter signal.

12. The apparatus of claim 11, the apparatus further comprising a jitter generator that:
generates white noise; and
filters the white noise with a third order Butterworth low pass filter with a cutoff frequency in the range of 2 to 10 Hz to generate the jitter signal.

13. The apparatus of claim 11, the apparatus further comprising a pitch/volume input that selects a selection of a pitch/volume pair and the signal modification module modifying the source signal pitch and source signal volume with the pitch/volume pair.

14. The apparatus of claim 10, the apparatus further comprising a source signal module that selects the source signal based on the discrete consonant input and the logical arc.

15. The apparatus of claim 14, wherein the source signal is selected from the group consisting of silence, white noise, a stored signal, a synthesized signal, and an input signal.

16. A program product comprising:
a computer readable storage medium storing program code, the program code executable by a processor to perform the functions of:
sequentially applying a vowel filter set to form a vowel with a source signal, the vowel filter set selected from a logical arc traversing a vowel filter array, the vowel filter array comprising a plurality of vowel filters organized as a logical space, wherein vowel filters traversed by the logical arc are selected; and
sequentially applying a consonant filter set from a consonant filter array to form a consonant with the source signal, the consonant filter set selected in response to a discrete consonant value.

17. The program product of claim 16, the program code further modifying the source signal with a jitter signal.

18. The program product of claim 17, the program code further:
generating white noise; and
filtering the white noise with a third order Butterworth low pass filter with a cutoff frequency in the range of 2 to 10 Hz to generate the jitter signal.

19. The program product of claim 16, wherein the vowel filter array comprises filter gradations between “u,” “i,” “I,” “I,” “o,” “e,” “Λ,” “ε,” “α,” and “æ” vowels.

20. The program product of claim 16, the program code further:
selecting a pitch/volume pair from a pitch/volume input; and
modifying the source signal pitch and source signal volume with the pitch/volume pair.
